(19) United States
(12) Patent Application Publication
(10) Pub. No.: US 2024/0347749 A1
(43) Pub. Date: Oct. 17, 2024

(54) FUEL CELL SYSTEM INCLUDING ANODE RECYCLE COOLER AND METHOD OF OPERATING THE SAME

(71) Applicant: BLOOM ENERGY CORPORATION, San Jose, CA (US)

(72) Inventors: Lorenzo PENNA, San Jose, CA (US); Samuel JUDAY, Sunnyvale, CA (US); Jayakumar KRISHNADASS, Sunnyvale, CA (US); Shiva Teja KONETI, Santa Clara, CA (US)

(21) Appl. No.: 18/630,890

(22) Filed: Apr. 9, 2024

Related U.S. Application Data
(60) Provisional application No. 63/496,647, filed on Apr. 17, 2023.

(51) Int. Cl. H01M 8/04701; H01M 8/04007; H01M 8/04014; H01M 8/04119; H01M 8/04302; H01M 8/0432; H01M 8/04746; H01M 8/2475

(52) U.S. Cl. CPC H01M 8/04716; H01M 8/04014; H01M 8/04074; H01M 8/04164; H01M 8/04302; H01M 8/04343; H01M 8/04761; H01M 8/2475

(57) ABSTRACT

A fuel cell system includes a housing, a hotbox disposed in the housing, a stack of fuel cells disposed in the hotbox and configured to generate an anode exhaust, and an anode recycle cooler (ARC) heat exchanger disposed in the housing outside the hotbox and configured to cool the anode exhaust received from the stack by transferring heat from the anode exhaust to air in the housing.

### FIELD

Aspects of the present invention relate to fuel cell systems and methods of operating the same, and more particularly, to fuel cell systems including an anode recycle cooler heat exchanger.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as solid oxide regenerative fuel cells, that also allow reversed operation, such that oxidized fuel can be reduced back to unoxidized fuel using electrical energy as an input.

### SUMMARY

According to various embodiments, a fuel cell system includes a housing, a hotbox disposed in the housing, a stack of fuel cells disposed in the hotbox and configured to generate an anode exhaust, and an anode recycle cooler (ARC) heat exchanger disposed in the housing outside the hotbox and configured to cool the anode exhaust received from the stack of fuel cells by transferring heat from the anode exhaust to air in the housing.

According to various embodiments, a method of operating a fuel cell system, comprises providing fuel to a stack of fuel cells disposed in a hotbox located in a housing to generate both power and an anode exhaust; providing the anode exhaust output from the hotbox to an anode recycle cooler (ARC) heat exchanger disposed in a housing outside of the hotbox; and cooling the anode exhaust in the ARC by transferring heat from the anode exhaust to air in the housing.

### BRIEF DESCRIPTION OF THE DRAWINGS

The accompanying drawings, which are incorporated herein and constitute part of this specification, illustrate example embodiments of the invention, together with the general description given above and the detailed description given below.

FIG. 1A illustrates a modular fuel cell system, according to various embodiments of the present disclosure, and FIG. 1B is a schematic view of a power module of the system of FIG. 1A.

FIG. 2A is a perspective view of the anode recycle cooler (ARC) of FIG. 1B, FIG. 2B is a perspective view of the ARC of FIG. 2A without the cooling fins, and FIG. 2C is a perspective view of a cooling fin of the ARC of FIG. 2A, according to various embodiments of the present disclosure.

FIG. 3 is a schematic view of an SOFC system, according to one embodiment of the present disclosure.

FIG. 4 is a schematic view of an SOFC system, according to another embodiment of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

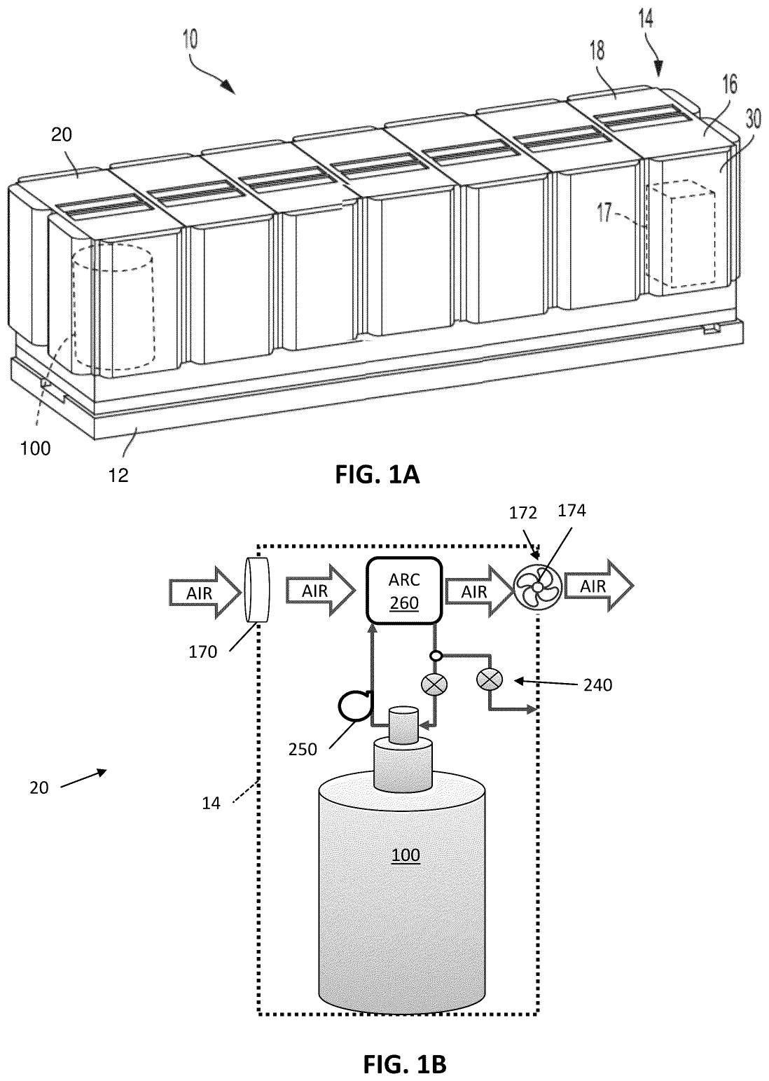

FIG. 1A illustrates a modular fuel cell system 10, according to various embodiments of the present disclosure. FIG. 1B is a schematic view of a power module 20 of the system 10 of FIG. 1A. The modular system 10 may contain modules and components described above as well as in U.S. Pat. No. 8,822,101 B2, which is incorporated herein by reference for descriptions of the modular fuel cell system. The modular design of the fuel cell system 10 provides for flexible system installation and operation.

The modular fuel cell system 10 includes a plurality of power modules 20 (containing fuel cell power module components), one or more fuel input (i.e., fuel processing) modules 16, and one or more power conditioning (i.e., electrical output) modules 18. For example, the system enclosure may include any desired number of modules, such as 2-30 power modules 20, for example 6-12 power modules 20. FIG. 1A illustrates the system 10 containing twelve power modules 20 (two rows of six modules stacked side to side in each row, and where the modules in the two rows are arranged back to back), one fuel processing module 16, and one power conditioning module 18, on a common base 12. Each module may comprise its own cabinet or housing. Alternatively, the power conditioning and fuel processing modules may be combined into a single input/output module located in one cabinet or housing 14.

While two rows of power modules 20 are shown, the system 10 may comprise more than two rows of power modules 20 or may comprise only one row of power modules 20. In addition, the power modules 20 may also be stacked in the vertical direction in some embodiments.

The modular fuel cell system 10 also contains one or more fuel processing modules 16. The fuel processing modules 16 may be designed to process different types of fuel. For example, a diesel fuel processing module, a natural gas fuel processing module, and an ethanol fuel processing module may be provided in the same or in separate cabinets. A different bed composition tailored for a particular fuel may be provided in each module. The fuel processing module(s) 16 may process at least one of the following fuels selected from natural gas provided from a pipeline, compressed natural gas, methane, propane, liquid petroleum gas, gasoline, diesel, home heating oil, kerosene, JP-5, JP-8, aviation fuel, hydrogen, ammonia, ethanol, methanol, syn-gas, bio-gas, bio-diesel and other suitable hydrocarbon or hydrogen containing fuels. If desired, a reformer 17 may be located in the fuel processing module 16. Alternatively, if it is desirable to thermally integrate the reformer 17 with the fuel cell stack(s), then a separate reformer 17 may be located in each hot box 100 in a respective power module 20. Furthermore, if internally reforming fuel cells are used, then an external reformer 17 may be omitted entirely.

The modular fuel cell system 10 also contains one or more power conditioning modules 18. The power conditioning module 18 includes components for converting the fuel cell stack generated DC power to AC power (e.g., an inverter), electrical connectors for AC power output to the grid, circuits for managing electrical transients, and a system controller (e.g., a computer or dedicated control logic device or circuit). The power conditioning module 18 may be designed to convert DC power from the fuel cell modules to different AC voltages and frequencies. Designs for 208V, 60 Hz; 480V, 60 Hz; 415V, 50 Hz and other common voltages and frequencies may be provided.

As shown in an example embodiment in FIG. 1A, one input/output cabinet 14 is provided for the power modules 20. If only a single row of power modules is used, the row of modules may be positioned, for example, adjacent to a building for which the system provides power (e.g., with the backs of the cabinets of the modules facing the building wall). In the single row configuration, the input/output cabinet 14 can be arranged on one end of the row while a fuel processing module 16 may be arranged on the same end of the row or on the opposite end of the row of power modules.

Referring to FIG. 1B, the power module 20 may include a hotbox 100 disposed in a housing 14. The hotbox 100 may contain one or more stacks or columns of fuel cells (not shown for clarity), such as one or more stacks or columns of solid oxide fuel cells having a ceramic oxide electrolyte separated by conductive interconnect plates. The fuel cells may generate electric power using a hydrocarbon fuel or hydrogen (H₂) provided to the hotbox 100. The fuel cells may also generate anode exhaust (e.g., fuel exhaust), and cathode exhaust (e.g., air exhaust).

The housing 14 may include an air inlet 170 and an air outlet 172, and an air circulation device 174, such as a fan or blower. For brevity, the air circulation device is described below as a fan 174 which is configured to circulate air though the housing 14, such that ambient air is pulled into the air inlet 170 and flows through the housing 14 to the outlet 172.

The power module 20 may also include anode exhaust flow control components 240, an optional anode recycle blower 250 and an anode recycle cooler (ARC) 260. The flow control components 240 may include, for example, recycling conduits, valves, blowers, etc., configured to control the flow of anode exhaust (i.e., the fuel exhaust stream from the fuel cell stacks) from the hotbox 100 to the ARC 260, and from the ARC 260 back to the hotbox 100 and/or out of the housing 14, as described in detail below.

If the anode exhaust is not passed through an anode tail gas oxidizer located in the hot box 100, then the anode exhaust may exit the hotbox 100 at a temperature ranging from about 190° C. to about 230° C. However, the flow control components 240, such as gas solenoid valves and/or blowers may have lower rated operating temperatures. While high-temperature versions of such components are available, such specialized components are more expensive and/or larger in size than their lower temperature equivalents.

Accordingly, the ARC 260 may be configured to reduce the temperature of the anode exhaust, in order to allow for the use of smaller, less expensive flow control components 240 that are rated for lower temperatures. In particular, the ARC 260 may be a heat exchanger configured to reduce the temperature of the anode exhaust by transferring heat from the anode exhaust to the cabinet air. For example, the ARC 260 may be configured to output anode exhaust at a temperature of less than about 190° C., such as a temperature ranging from about 150° C. to about 185° C.

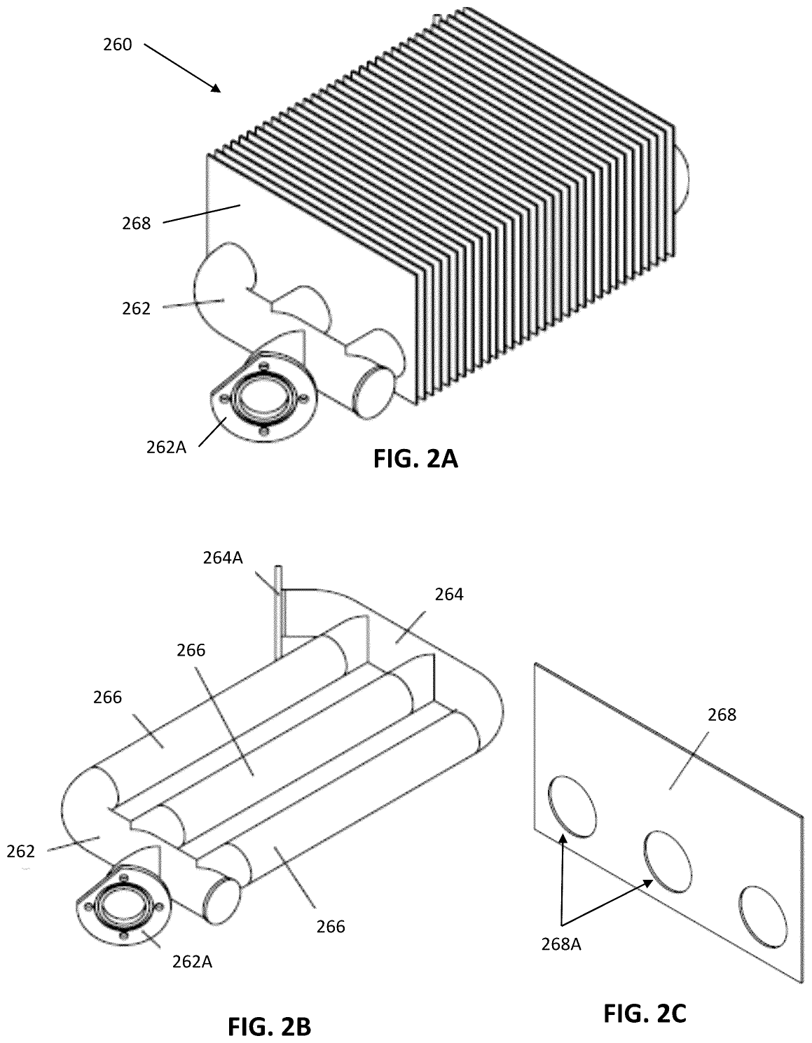

The ARC 260 may comprise any suitable heat exchanger which can exchange heat between cabinet air and the anode exhaust exiting the hot box. For example, as shown in FIGS. 2A-2C, the ARC 260 may comprise a fin and tube heat exchanger in which one fluid flows through finned tubes, while the other fluid flows outside the finned tubes. Preferably, the anode exhaust flows through the insides of the finned tubes while the cabinet air flows outside the finned tubes. Referring to FIGS. 2A-2C, one embodiment of the ARC 260 may include an inlet manifold 262, an outlet manifold 264, heat exchange conduits (e.g., tubes) 266, and the cooling fins 268 located on the outer surfaces of the conduits 266.

The inlet manifold 262 may include an inlet coupling 262A, and the outlet manifold 264 may include an outlet coupling 264A, which may be configured to connect the ARC to respective anode exhaust recycling conduits. The inlet manifold 262 may be configured to divide a received anode exhaust stream among the heat exchange conduits 266, and the outlet manifold 264 may be configured to collect anode exhaust received from the heat exchange conduits 266.

While three heat exchange conduits 266 are shown in FIGS. 2A and 2B, the present disclosure is not limited to any particular number of heat exchange conduits 266. For example, the ARC 260 may include from 1 to 6 heat exchange conduits 266. However, in some embodiments the ARC 260 may preferably include at least three heat exchange conduits 266, in order to minimize a drop in anode exhaust pressure as the anode exhaust flows though the ARC 260. For example, the ARC 260 may be configured to provide a pressure drop of 0.5 psi or less, such as a pressure drop ranging from about 0.25 psi to about 0.025 psi, from about 0.1 psi to about 0.01 psi.

The heat exchange conduits 266 may extend through openings 268A of the cooling fins 268. In various embodiments, the cooling fins 268 may be welded or press-fit onto the heat exchange conduits 266. The manifolds 262, 264, heat exchange conduits 266, and/or the cooling fins 268 may be formed of a highly thermally conductive material, such as aluminum, stainless steel, Inconel or other suitable metals or metal alloys.

In various embodiments, the ARC 260 may be configured to reduce the temperature of the anode exhaust by from about 10° C. to about 50° C., such as from about 15° C. to about 44° C., or from about 30° C. to about 35° C. In operation, the air circulation device 174, such as a fan or blower, draws ambient air into the housing 14 through the inlet to provide the cabinet air. The cabinet air flows past the fins 268 and heat exchange conduits 266 of the ARC 260 and then exits the housing 14 through the outlet 174. The anode exhaust flows from the hot box 100 through the flow control components 240 (e.g., through the recycling conduits which are coupled to the inlet coupling 262A) into the ARC 260. The optional anode recycle blower 250 may be used to blow the anode exhaust from the hot box 100 into the ARC 260. In the ARC, the anode exhaust flows through the inlet manifold 262, the heat exchange conduits 266 and the outlet manifold 264, where the anode exhaust exchanges heat with the cabinet air flowing on the outside of the ARC 260. The cooled anode exhaust then flows from the ARC 260 back through the flow control components 240 (e.g., through the recycling conduits which are coupled to the outlet coupling 264A) into the hot box 100 and/or out of the cabinet 14.

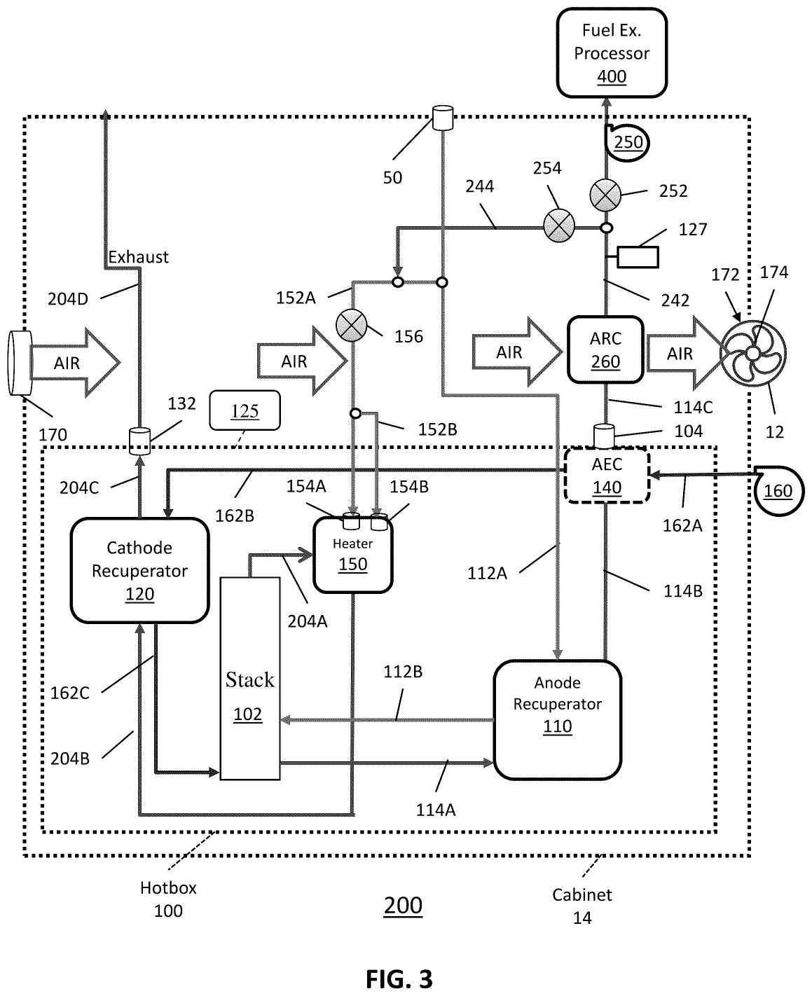

FIG. 3 is a schematic representation of a SOFC system 200 that may be used as a power module 20 of FIG. 1, according to one embodiment of the present disclosure. The system 200 may be configured to operate using hydrogen gas (H₂) as a fuel, according to one embodiment of the present disclosure.

Referring to FIG. 3, the system 200 may include a housing 14 in which a hotbox 100 and various other components are disposed. The hot box 100 may contain stacks 102 of fuel cells, such as solid oxide fuel cells, separated by interconnects. Solid oxide fuel cells of the stacks 102 may contain a ceramic electrolyte, such as yttria stabilized zirconia (YSZ), scandia stabilized zirconia (SSZ), scandia and ceria stabilized zirconia or scandia, yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 102 may be internally or externally manifolded for fuel.

The system 200 may also contain an anode recuperator 110 heat exchanger, a cathode recuperator 120 heat exchanger, a startup heater 150, and the anode recycle cooler (ARC) 260. In some embodiments, the system 200 may optionally include an anode exhaust cooler 140 and/or a recycle blower 250. The system 200 may also include a main air blower 160 (e.g., system blower), which may be disposed outside of the hotbox 100. However, the present disclosure is not limited to any particular location for each of the module components with respect to the hotbox 100.

The anode recuperator 110 receives fuel (e.g., H₂) from a fuel inlet 50 through a fuel conduit 112A. The fuel is heated in the anode recuperator 110 by anode exhaust (e.g., fuel exhaust) output from the stack 102, before being provided to the stack 102 by a fuel conduit 112B. A first heater conduit 152A may fluidly connect the fuel inlet 50 to the startup heater 150. A second heater conduit 152B may also fluidly connect the fuel inlet 50 to the startup heater 150. Accordingly, the startup heater 150 may receive fuel provided by either or both of the first and second heater conduits 152A, 152B. The conduits 112A, 152A and 152B may be fluidly connected to the fuel inlet 50 using any suitable fluid connectors. For example, the fuel conduit 112A may be connected to the fuel inlet 50, the first heater conduit 152A may be connected to the fuel conduit 112A at a first two way splitter downstream of the fuel inlet 50, and the second heater conduit 152B may be connected to the first heater conduit 152B at a second two way splitter downstream of the first two way splitter as shown in FIG. 1. Alternatively, a single three way splitter may split fuel from the fuel inlet 50 into all three conduits 112A, 152A and 152B. Other fluid connections may also be used to connect the fuel inlet 50 to the three conduits 112A, 152A and 152B. The first and second heater conduits 152A, 152B may be connected to the same or different fuel inlets of the startup heater 150. For example, the startup heater 150 may include a heating fuel inlet 154A and/or an ignition fuel inlet 154B connected to respective heater conduits 152A and 152B.

The startup heater 150 may also receive air exhaust (i.e., cathode exhaust) output from the stack 102 through an exhaust conduit 204A. The startup heater 150 may include a fuel oxidation catalyst (e.g., a noble metal catalyst) and/or heating element (e.g., resistive and/or radiative heating element). The startup heater 150 may generate heat by catalytically and/or thermally oxidizing received fuel using the air exhaust. In some embodiments, the startup heater 150 may be referred to as an anode tail gas oxidizer (ATO).

Exhaust output from the startup heater 150 may be provided to the cathode recuperator 120 through exhaust conduit 204B. Exhaust output from the cathode recuperator 120 may be exhausted from the hotbox 100 through exhaust conduit 204C and exhaust outlet 132. An exhaust conduit 204D may be configured to receive exhaust output from the exhaust outlet 132. In some embodiments, the exhaust conduit 204D may be part of, or connected to, an exhaust manifold configured to receive exhaust output from multiple hotboxes 100.

The main air blower 160 may be configured to provide air (e.g., an air inlet stream) to the anode exhaust cooler 140 through air conduit 162A. Air flows from the anode exhaust cooler 140 to the cathode recuperator 120 through air conduit 162B. The air is heated in the cathode recuperator 120 by the air exhaust output from the stack 102 (or by startup heater 150 exhaust output if the fuel is also provided to the startup heater 150, where the fuel is oxidized by the air exhaust to form the oxidized fuel heater exhaust output). The heated air flows from the cathode recuperator 120 to the stack 102 through air conduit 162C.

Anode exhaust (e.g., an anode exhaust stream generated in the stack 102) is provided to the anode recuperator 110 through anode exhaust conduit 114A. The anode exhaust may contain unreacted hydrogen fuel and water and may also be referred to herein as fuel exhaust. Anode exhaust output from the anode recuperator 110 may be provided to an anode exhaust outlet 104 of the hotbox 100, by anode exhaust conduit 114B. In some embodiments, the optional anode exhaust cooler 140 may be configured to cool the anode exhaust provided by the anode exhaust conduit 114B using the inlet air stream provided by the air conduit 162A, prior to the anode exhaust reaching the anode exhaust outlet 104.

The system 200 may also include an anode exhaust conduit 114C, a first recycling conduit 242, and a second recycling conduit 244. The anode exhaust conduit 114C may be configured to fluidly connect the anode exhaust outlet 104 to an inlet (e.g., the inlet coupling 262A) of the ARC 260. The first recycling conduit 242 may be configured to fluidly connect an outlet (e.g., the outlet coupling 264A) of the ARC 260 to a fuel exhaust processor 400.

The second recycling conduit 244 may be configured to fluidly connect the first recycling conduit 242 to the first heater conduit 152A. In the alternative, the second recycling conduit 244 may be configured to fluidly connect the first recycling conduit 242 to the fuel conduit 112A. The system 200 may be configured such that the anode exhaust flowing through the second recycling conduit 244 may be provided to either the heater 150 or the anode recuperator 110, depending on system requirements.

The system 200 may also include a product valve 252, a bypass valve 254, and a heater valve 156. The product valve 252 may be configured to control anode exhaust flow through the first recycling conduit 242 to the fuel exhaust processor 400. The bypass valve 254 may be configured to control anode exhaust flow through the second recycling conduit 244 to conduit 152A. The heater valve 156 may be configured to control anode exhaust flow through the first heater conduit 152A. The valves 252, 254, 156 may be any suitable type of valve, such as a proportionate valve, such as a gas solenoid valve or the like. The system 200 may optionally comprise a recycle blower 250 configured to increase anode exhaust flow to the fuel exhaust processor 400.

The housing 14 may include the air inlet 170, the air outlet 172, and the air circulation device (e.g., fan) 174. The fan 174 may be configured to circulate air through the housing 14, such that ambient air is pulled into the air inlet 170, flows through the housing 14, and flows out of the outlet 172. For example, the fan 174 may be disposed inside of the air outlet 172 or outside of the housing 14 adjacent to the air outlet 172. However, in other embodiments the fan may be disposed in the air inlet 170 or outside of the housing 14 adjacent to the air inlet 170.

The ARC 260 may be disposed in the housing 14 outside of the hotbox 100. In some embodiments, the ARC 260 may be disposed on a portion of a central column that extends outside of the hotbox. The central column may include the anode recuperator 110, the cathode recuperator 120, the startup heater 150, and the optional anode exhaust cooler 140, and may be surrounded by the fuel cell stacks 102. In particular, the anode recuperator 110 may be disposed radially inward of the startup heater 150, and the anode exhaust cooler 140 may be mounted over the anode recuperator 110 and the startup heater 150.

The ARC 260 may be configured to cool the anode exhaust by transferring heat to the cabinet air flowing through the housing 14. In particular, the ARC 260 may be configured to cool the anode exhaust to a temperature below a rated operating temperature of the valves 252, 254, 156 and/or the optional recycle blower 250. For example, the ARC 260 may be configured to output the anode exhaust at a temperature of about 190° C. or less, such as a temperature ranging from about 150° C. to about 190° C., such as from about 175° C. to about 185° C.

The fuel exhaust processor 400 may be configured to separate the anode exhaust into various components. For example, the fuel exhaust processor 400 may include a condenser to separate the hydrogen in the anode exhaust from water. In some embodiments the fuel exhaust processor 400 may also include a hydrogen storage device, such as a hydrogen storage tank.

The system 200 may further comprise a system controller 125 and a temperature sensor 127. The system controller 125 may be configured to control various elements of the system 200. The controller 125 may include a central processing unit configured to execute stored instructions. For example, the controller 125 may be configured to control the air flow through the system 200 and to open and close the fuel flow to the system 200.

The temperature sensor 127 may be configured to detect the temperature of anode exhaust in the first recycling conduit 242. In some embodiments, the controller 125 may be configured to control the speed of the fan 174 based on the temperature of the anode exhaust detected by the temperature sensor 127. For example, the controller 125 may be configured to increase the speed of the fan 174 if the temperature of the anode exhaust exceeds a rated operating temperature of one or more system components exposed to the output anode exhaust.

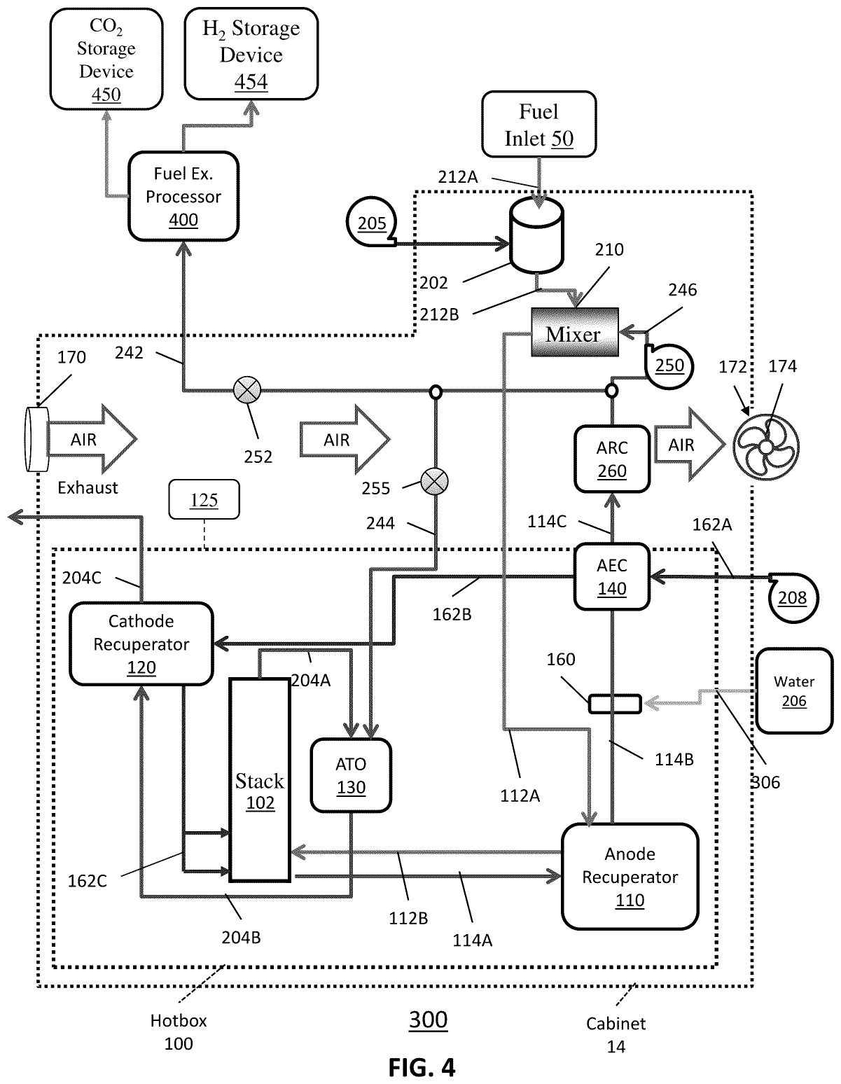

FIG. 4 is a schematic representation of an SOFC system 300, according to an alternative embodiment of the present disclosure. The system 300 may include components similar to those described with respect to the system 200 of FIG. 3 and may also be used as a power module 20 of FIG. 1A. The system 300 may operate on a hydrocarbon fuel (e.g., natural gas, etc.) and the anode exhaust may bypass the anode tail gas oxidizer during steady state operation of the system 300.

Referring to FIG. 4, the system 300 includes a hotbox 100 disposed in a housing 14, and various components disposed therein or adjacent thereto. The hotbox 100 may contain at least one fuel cell stack 102, such as a solid oxide fuel cell stack containing alternating fuel cells and interconnects. One solid oxide fuel cell of the stack contains a ceramic electrolyte, such as yttria stabilized zirconia (YSZ), scandia stabilized zirconia (SSZ), scandia and ceria stabilized zirconia or scandia, yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 102 may be arranged over each other in a plurality of columns.

The hotbox 100 may also contain an anode recuperator heat exchanger 110, a cathode recuperator heat exchanger 120, an anode tail gas oxidizer (ATO) 130, an anode exhaust cooler heat exchanger 140, and a water injector 160. The system 300 may also include a catalytic partial oxidation (CPOx) reactor 202, a mixer 210, a CPOx blower 205 (e.g., air blower), a system blower 208 (e.g., air blower), an anode recycle blower 250, and the ARC 260, which may be disposed outside of the hotbox 100. However, the present disclosure is not limited to any particular location for each of the components with respect to the hotbox 100.

The housing 14 may include the air inlet 170, the air outlet 172, and the air circulation device (e.g., fan) 174. The fan 174 may be configured to pull air from the housing 14, such that ambient air is pulled into the air inlet 170 and flows through the housing 14 as the cabinet air to the outlet 172. In general, the temperature of the air in the housing 14 may range from about 10° C. to about 20° C., such as about 15° C. higher than the temperature of ambient air outside of the housing 14.

The CPOx reactor 202 receives a fuel inlet stream through fuel conduit 212A from a fuel inlet 50. The fuel inlet 50 may be a fuel tank or a utility natural gas line including a valve to control an amount of fuel provided to the CPOx reactor 202. The CPOx blower 205 may provide air to the CPOx reactor 202 during system start-up. The fuel and/or air may be provided to the mixer 210 by fuel conduit 212B. Fuel flows from the mixer 210 to the anode recuperator 110 through fuel conduit 112A. The fuel is heated in the anode recuperator 110 by the anode exhaust and the fuel then flows from the anode recuperator 110 to the stack 102 through fuel conduit 112B.

The system blower 208 may be configured to provide an air stream (e.g., air inlet stream) to the anode exhaust cooler 140 through air conduit 162A. Air flows from the anode exhaust cooler 140 to the cathode recuperator 120 through air conduit 162B. The air is heated by the ATO exhaust in the cathode recuperator 120. The air flows from the cathode recuperator 120 to the stack 102 through air conduit 162C.

Water flows from a water source 206, such as a water tank or a water pipe, to the water injector 160 through a water conduit 306. The water injector 160 may be configured to inject water into anode exhaust flowing through the anode exhaust conduit 114B. Heat from the anode exhaust (also referred to as a recycled anode exhaust stream) vaporizes the water to generate steam which humidifies the anode exhaust. The humidified anode exhaust is provided to the anode exhaust cooler 140. Heat from the anode exhaust provided to the anode exhaust cooler 140 may be transferred to the air inlet stream provided from the system blower 208 to the cathode recuperator 120. The cooled humidified anode exhaust may then be provided from the anode exhaust cooler 140 to the mixer 210 via the ARC 260. The anode recycle blower 250 may be configured to move the anode exhaust though the first recycling conduit 242.

The mixer 210 is configured to mix the humidified anode exhaust with fresh fuel (i.e., fuel inlet stream). This humidified fuel mixture may then be heated in the anode recuperator 110 by the anode exhaust, before being provided to the stack 102. The system 300 may also include one or more fuel reforming catalysts located inside and/or downstream of the anode recuperator 110. The reforming catalyst(s) reform the humidified fuel mixture before it is provided to the stack 102.

Cathode exhaust generated in the stack 102 is provided to the ATO 130 by cathode exhaust conduit 204A. The cathode exhaust may be mixed with the anode exhaust before or after being provided to the ATO 130. The mixture of the anode exhaust and the cathode exhaust may be oxidized in the ATO 130 to generate an ATO exhaust. The ATO exhaust flows from the ATO 130 to the cathode recuperator 120, through cathode exhaust conduit 204B. Exhaust flows from the cathode recuperator 120 and out of the hotbox 100 and housing 14 through cathode exhaust conduit 204C.

Anode exhaust (e.g., an anode exhaust stream) generated in the stack 102 is provided to the anode recuperator 110 through an anode exhaust conduit 114A. The anode exhaust may contain unreacted fuel and may also be referred to herein as fuel exhaust. The anode exhaust may be provided from the anode recuperator 110 to the anode exhaust cooler 140 by anode exhaust conduit 114B. The anode exhaust may be provided from the anode exhaust cooler 140 to the ARC 260 by anode exhaust conduit 114C. In particular, the anode exhaust conduit 114C may fluidly connect an outlet of the anode exhaust cooler 140 to an inlet (e.g., 262A) of the ARC 260. The anode exhaust may be cooled in the ARC 260 by the cabinet air and then provided from the ARC outlet (e.g., 264A) to a fuel exhaust processor 400 by a first recycling conduit 242. The first recycling conduit 242 may fluidly connect an outlet (e.g., 264A) of the ARC 260 to an inlet of fuel exhaust processor 400.

The system 300 may also include a second recycling conduit 244 and a third recycling conduit 246. The second recycling conduit 244 may be configured to fluidly connect the first recycling conduit 242 to the ATO 130. The third recycling conduit 246 may be configured to fluidly connect the first recycling conduit 242 to the mixer 210. A recycle blower 250 may be included to move anode exhaust through the third recycling conduit 246.

Anode exhaust flow through the first recycling conduit 242 to the fuel exhaust processor 400 may be controlled by a product valve 252. Anode exhaust flow through the second recycling conduit 244 to the ATO 130 may be controlled by an ATO valve 255. The ATO valve 255 may be open during start-up of the system 300 to generate the ATO exhaust which heats the system 300. The ATO valve 255 may be closed during steady-state operation of the system 300 once the system 300 reaches the desired steady-state operating temperature. Thus, the anode exhaust does not flow through the ATO 130 during steady-state operation of the system 300.

The ARC 260 may configured to cool the anode exhaust by transferring heat to the cabinet air in the housing 14. In particular, the ARC 260 may be configured to cool the anode exhaust to a temperature below a rated operating temperature of the valves 252, 256 and/or the optional anode recycle blower 250. For example, the ARC 260 may be configured to output the anode exhaust at a temperature of about 190° C. or less, such as a temperature ranging from about 150° C. to about 190° C., such as from about 170° C. to about 185° C.

The fuel exhaust processor 400 may be configured to purify and/or separate the anode exhaust into various components. For example, the fuel exhaust processor 400 may include components such as a hydrogen separator, a low temperature shift reactor, and a heat exchanger, in order to purify the anode exhaust and/or separate the anode exhaust into hydrogen and carbon dioxide streams. The system 300 may include a carbon dioxide storage device 450 to store the carbon dioxide and a hydrogen storage device 454 to store the hydrogen.

The system 300 may further include a system controller 125 configured to control various elements of the system 300. The controller 125 may include a central processing unit configured to execute stored instructions. For example, the controller 125 may be configured to control fuel and/or air flow through the system 300, according to fuel composition data. In some embodiments, the controller 125 may be configured to control the speed of the fan 174 based on a temperature of the anode exhaust output from the ARC 260. For example, the controller 125 may be configured to increase the speed of the fan if the temperature of the anode exhaust exceeds a rated operating temperature of one or more system components exposed to the output anode exhaust.

Referring again to FIGS. 3 and 4, the present inventors have determined that during steady-state operations when a sufficient electrical load is applied to a fuel cell stack, ATO heat generation may not be required to maintain the SOFC stack 102 at the desired steady-stage operating temperature (e.g., a temperature above 700° C., such as 750 to 900° C.). As such, the systems 200 and 300 may be configured such that anode exhaust flow to the heater 150 or the ATO 130 during steady-state operation is reduced or cut off. In other words, the amount of anode exhaust provided to the ATO 130 (or the heater 150) may be significantly reduced during steady-state operation, as compared to startup operation, thereby improving the efficiency of the systems 200 and 300.

In contrast, comparative fuel cell systems generally provide a constant amount of anode exhaust to operate an ATO during steady-state and startup operations. For example, portion of generated anode exhaust may be diverted from an anode exhaust stream flowing between an anode recuperator and an anode exhaust cooler, in order to maintain a reaction temperature and/or oxidize carbon monoxide present in the anode exhaust provided thereto. As such, the amount of anode exhaust provided to an anode exhaust cooler of a comparative system may be significantly less than the total amount of anode exhaust produced.

In the systems 200 and 300, the anode exhaust may be output from the hotboxes 100 at a relatively high temperature of above 190° C. Such high anode exhaust temperatures would conventionally require the use of specialized components, such as high temperature rated valves and blowers, which are more expensive than lower temperature rated valves and blowers. In contrast, the addition of the ARC 260 to the embodiment systems 200 and 300 reduces the temperature of the anode exhaust, which prevents system components 240 from being exposed to high temperatures above 190° C. As such, the ARC 260 allows the embodiment systems 200 and 300 to be operated without the use of expensive high temperature rated components. As such, the ARC 260 beneficially provides a low cost anode exhaust temperature management solution that is easily integrated into the limited space of the housing 14.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A fuel cell system, comprising:
a housing;
a hotbox disposed in the housing;
a stack of fuel cells disposed in the hotbox and configured to generate an anode exhaust; and
an anode recycle cooler (ARC) heat exchanger disposed in the housing outside the hotbox and configured to cool the anode exhaust received from the stack by transferring heat from the anode exhaust to air in the housing.

2. The fuel cell system of claim 1, wherein the ARC comprises a fin and plate heat exchanger.

3. The fuel cell system of claim 2, wherein the ARC comprises:
heat transfer conduits;
an inlet manifold configured to provide the anode exhaust to the heat transfer conduits;
an outlet manifold configured to collect the anode exhaust from the heat transfer conduits; and
cooling fins extending from the heat transfer conduits.

4. The fuel cell system of claim 3, wherein the ARC comprises at least three of the heat transfer conduits.

5. The fuel cell system of claim 1, further comprising:
a housing air inlet;
a housing air outlet; and
an air circulation device configured to circulate air from the housing air inlet through the housing and past the ARC and out through the housing air outlet.

6. The fuel cell system of claim 5, wherein the air circulation device comprises a fan disposed in the housing air outlet.

7. The fuel cell system of claim 6, further comprising a temperature sensor configured to detect a temperature of cooled anode exhaust output from the ARC.

8. The fuel cell system of claim 1, further comprising an anode recuperator heat exchanger and an anode exhaust cooler heat exchanger disposed in the hotbox and configured to successively receive the anode exhaust from the stack.

9. The fuel cell system of claim 8, further comprising an anode exhaust conduit fluidly connecting an outlet of the anode exhaust cooler to an inlet of the ARC.

10. The fuel cell system of claim 1, further comprising:
a hydrogen fuel inlet fluidly connected to the stack; and
a fuel exhaust processor containing a condenser configured to separate the anode exhaust output from the ARC into water and hydrogen.

11. The fuel cell system of claim 1, further comprising:
a hydrocarbon fuel inlet fluidly connected to the stack; and
a fuel exhaust processor configured to separate the anode exhaust output from the ARC into carbon dioxide and hydrogen.

12. The fuel cell system of claim 11, further comprising an anode tail gas oxidizer (ATO) and an ATO valve, wherein the ATO valve is configured to provide the anode exhaust into the ATO during a start-up operation of the fuel cell system, and to prevent the anode exhaust from flowing into the ATO during a steady-state operation of the fuel cell system.

13. A method of operating a fuel cell system, comprising:
providing fuel to a stack of fuel cells disposed in a hotbox located in a housing to generate power and an anode exhaust;
providing the anode exhaust output from the hotbox to an anode recycle cooler (ARC) heat exchanger disposed in a housing outside of the hotbox; and
cooling the anode exhaust in the ARC by transferring heat from the anode exhaust to air in the housing.

14. The method of claim 13, further comprising circulating the air through the housing.

15. The method of claim 13, wherein the fuel comprises a hydrogen fuel.

16. The method of claim 15, further comprising providing the hydrogen fuel into a heater located in the hotbox during start-up operation and not providing the hydrogen fuel into the heater during steady-state operation.

17. The method of claim 15, further comprising separating hydrogen from water in the cooled anode exhaust.

18. The method of claim 13, wherein the fuel comprises a hydrocarbon fuel.

19. The method of claim 18, further comprising providing the anode exhaust into an anode tail gas oxidizer (ATO) during start-up operation and not providing the anode exhaust into the ATO during steady-state operation.

20. The method of claim 18, further comprising separating hydrogen from carbon dioxide in the cooled anode exhaust.
